(19) United States
(12) Patent Application Publication
(10) Pub. No.: US 2010/0272842 A1
(43) Pub. Date: Oct. 28, 2010

(54) MOLD ASSEMBLY

(75) Inventors: CHIN-WEN YEH, Tu-Cheng (TW); ZHI-JIAN PENG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/506,710

(22) Filed: Jul. 21, 2009

(30) Foreign Application Priority Data
Apr. 25, 2009 (CN) 200920302588.0

(51) Int. Cl. B29C 33/00

(52) U.S. Cl. 425/116

(57) ABSTRACT

A mold assembly includes an upper mold and a lower mold. The upper mold defines an upper mold cavity. A plurality of punch pins are movably mounted in the upper mold. A channel is defined in the upper mold and in communication with the upper mold cavity. The lower mold is closed with the upper mold. The lower mold defines a lower mold cavity together with which the upper mold cavity forms a closed cavity. The closed cavity receives a work piece located therein. The mold assembly is movable between a first position and a second position. In the first position, the punch pins of the upper mold are punched into the work piece to from the work piece into predetermined shape. In the second position, the punch pins are moved out of the upper mold cavity. Molten plastic flows in the closed cavity via the channel to from plastic ornaments on the work piece.

### BACKGROUND

1. Technical Field

The present embodiment relates to mold assemblies, and particularly to a mold assembly that assembles a stamping mold and an injection mold.

2. Description of Related Art

Computers have becomes increasingly popular for general use. Manufacturers are striving to design varieties of portable computers to please users. Therefore, the ornamental design of the enclosure of the computer becomes more and more important for attracting users. Many plastic ornaments, which have different shapes and colors, are attached on the computer enclosure to beautify the computer enclosure. However, for manufacturing these computer enclosures, the procedure is complex. Firstly, stamping molds to stamp metal plates into required shapes to form a computer chassis are needed. Then, an injection mold to shape the plastic ornaments is needed. At last, the plastic ornaments are mounted on the computer chassis. The above procedure costs much time and money, and is inefficient.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and schematic view of an embodiment of a mold assembly and a work piece;

FIG. 2 is an assembled view of the mold and the work piece of FIG. 1; and

FIG. 3 is another assembled view of the mold and the work piece of FIG. 1.

### DETAILED DESCRIPTION

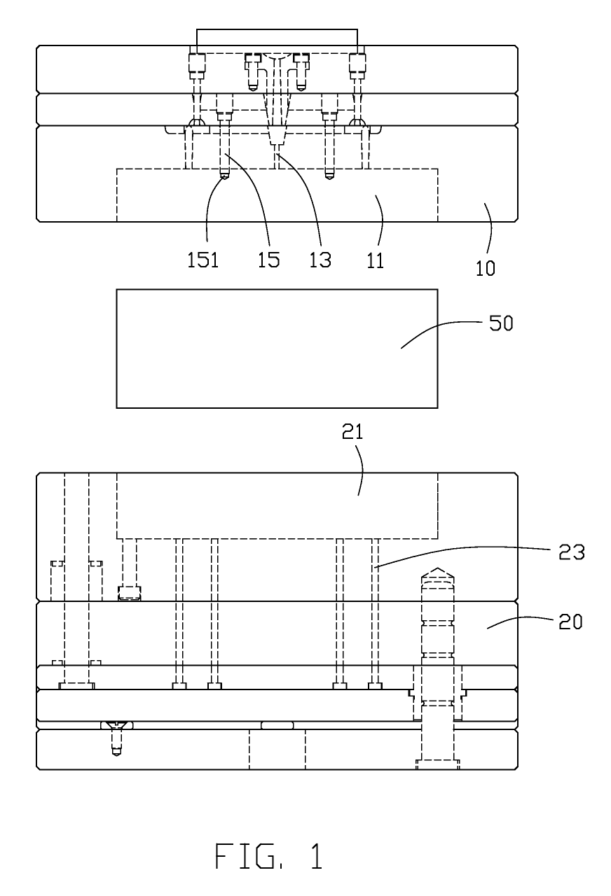

Referring to FIG. 1, a mold assembly is used to process a work piece 50. The mold assembly includes an upper mold 10 and a lower mold 20.

The upper mold 10 defines an upper mold cavity 11 in a bottom side thereof. A plurality of punch pins 15 is movably mounted in the upper mold 10. Each punch pin 15 is capable of moving in the upper mold 10 causing a distal end 151 of the punch pin 15 to be located either in the upper mold cavity 11 or out of the upper mold cavity 11. A channel 13 is defined in the upper mold 10. A first end of the channel 13 is in communication with an outside of the upper mold 10, and a second end of the channel 13 is in communication with the upper mold cavity 11.

The lower mold 20 defines a lower mold cavity 21 in a top side thereof. The lower mold cavity 21 and the upper mold cavity 22 are capable of together forming a closed cavity 30. A plurality of lifting pins 23 are movably mounted in the lower mold 20 for removing the work piece 50 out of the lower mold cavity 21.

The work piece 50 is a plate made of a metal such as steel, copper, or aluminum, and so on. A size of the closed cavity 30 is sized to receive the work piece 50 therein.

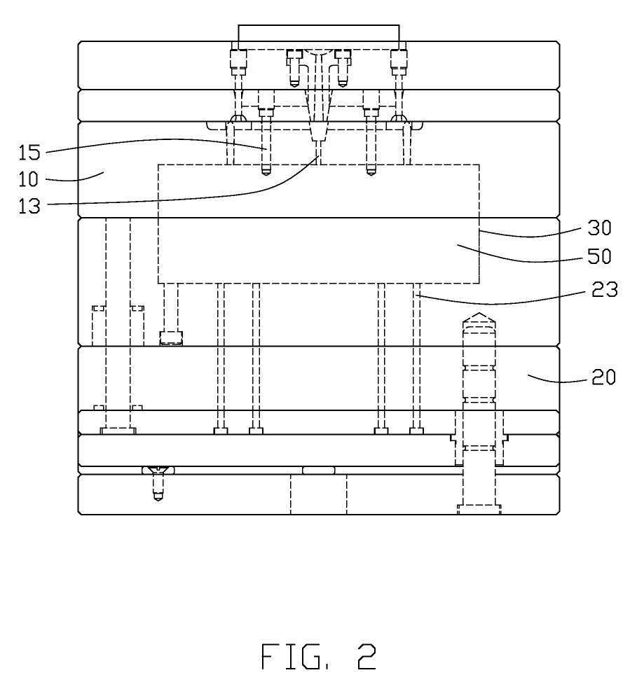

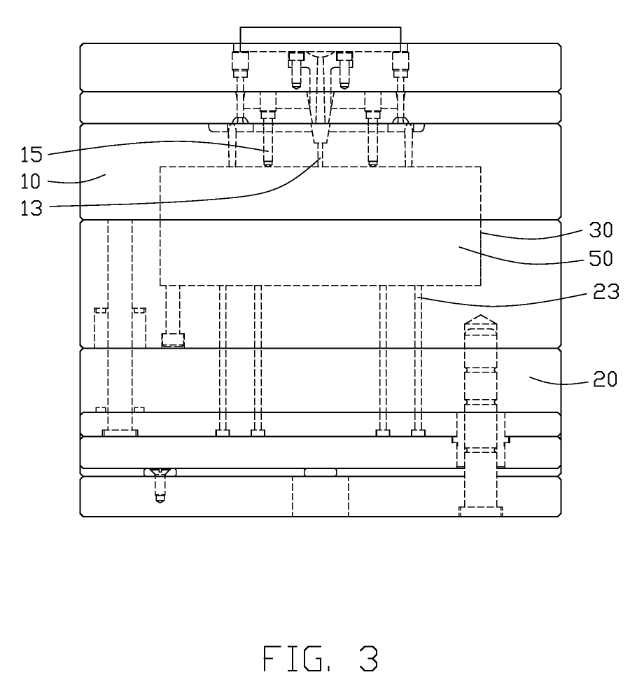

Referring to FIGS. 2 and 3, for processing the work piece 50, the work piece 50 is firstly put into the lower mold cavity 21 of the lower mold 20. The upper mold 10 and the lower mold 20 are closed. The punch pins 15 of the upper mold 10 are punched into the work piece 50 to form the work piece 50 into predetermined shape. The punch pins 15 are then retracted out of the upper mold cavity 10. An injection molding machine (not shown) injects molten plastic into the upper mold 10 via the channel 13. The molten plastic flows in the closed cavity 30 to form plastic ornaments on the work piece 50. After the work piece 50 and mold assembly are cooled, the upper mold 10 and lower mold 20 are opened. The lifting pins 23 of the lower mold 20 push the work piece 50 with the plastic ornaments integratedly formed thereon out of lower mold cavity 21.

By using the present mold assembly, the procedure of forming the work piece 50 into predetermined shapes and integrating the plastic ornaments with the work piece 50 are completed in one step and one position on a factory line. This improves efficiency, saves time and saves money.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A mold assembly, comprising:
an upper mold defining an upper mold cavity, a plurality of punch pins movably mounted in the upper mold, a channel defined in the upper mold and in communication with the upper mold cavity; and
a lower mold, the lower mold defining a lower mold cavity together with which the upper mold cavity forms a closed cavity, the closed cavity receiving a work piece located therein;
wherein the mold assembly is movable between a first position and a second position; in the first position, the punch pins of the upper mold are punched into the work piece to from the work piece into predetermined shape; in the second position, the punch pins are retracted out of the upper mold cavity, and a plurality of molten plastic flows in the closed cavity via the channel to form plastic ornaments on the work piece.

2. The mold assembly of claim 1, wherein the lower mold comprises a plurality of lifting pins capable of displacing the work piece in the lower mold cavity.

3. The mold assembly of claim 1, wherein the upper mold cavity is defined in a bottom side of the upper mold, and the lower mold cavity is defined in a top side of the lower mold.

4. The mold assembly of claim 3, wherein an end of the channel is in communication with an outside of the upper mold capable of receiving input from an injection molding machine.

5. A mold assembly, comprising:
an upper mold and a lower mold defining a cavity capable of receiving a work piece, the upper mold or the lower mold movably mounting a plurality of punch pins capable of punching into the work piece to form the work piece into predetermined shape, one of the upper mold or the lower mold defining a channel capable of guiding molten plastic to the cavity.

6. The mold assembly of claim 5, wherein the upper mold defines an upper mold cavity, the lower mold defines a lower mold cavity, the upper mold cavity and the lower mold cavity together form the cavity.

7. The mold assembly of claim 6, wherein the upper mold cavity is defined in a bottom side of the upper mold, and the lower mold cavity is defined in a top side of the lower mold.

8. The mold assembly of claim 5, wherein an end of the channel is in communication with an outside of the mold assembly capable of receiving input from an injection molding machine.

9. The mold assembly of claim 5, wherein the lower mold comprises a plurality of lifting pins capable of displacing the work piece in the lower mold cavity.
